(19) United States
(12) Patent Application Publication
(10) Pub. No.: US 2003/0197424 A1
(43) Pub. Date: Oct. 23, 2003

(54) Drive and/or braking device

(76) Inventors: Ronald Frey, Bonnigheim (DE); Harald Schmidt, Zaberfeld (DE); Johannes Helmich, Wertheim (DE); Birgit Scheytt, Vaileiuger (DE); Werner Baeskow, Hessigheim (DE)

Correspondence Address: YOUNG & BASILE, PC, Suite 624, 3001 West Big Beaver Road, Troy, MI, 48084-3107, US

(21) Appl. No.: 10/318,973

(22) Filed: Dec. 12, 2002

(30) Foreign Application Priority Data
Dec. 12, 2001 (DE) 101 60 848.9

(51) Int. Cl. B60T 13/74

(52) U.S. Cl. 303/3

(57) ABSTRACT

The invention relates to a drive and/or braking device, specifically to be installed in motor vehicles, having an electric drive unit and/or an electromagnetic brake unit, where a shaft can be driven by the drive unit and/or braked by the brake unit, having a closed, specifically water- and air-tight housing accommodating the drive and/or brake unit, and a wiring harness to connect the drive device to a source of current. The invention is characterized in that the wiring loom has at least one hollow lead to vent the interior of the housing.

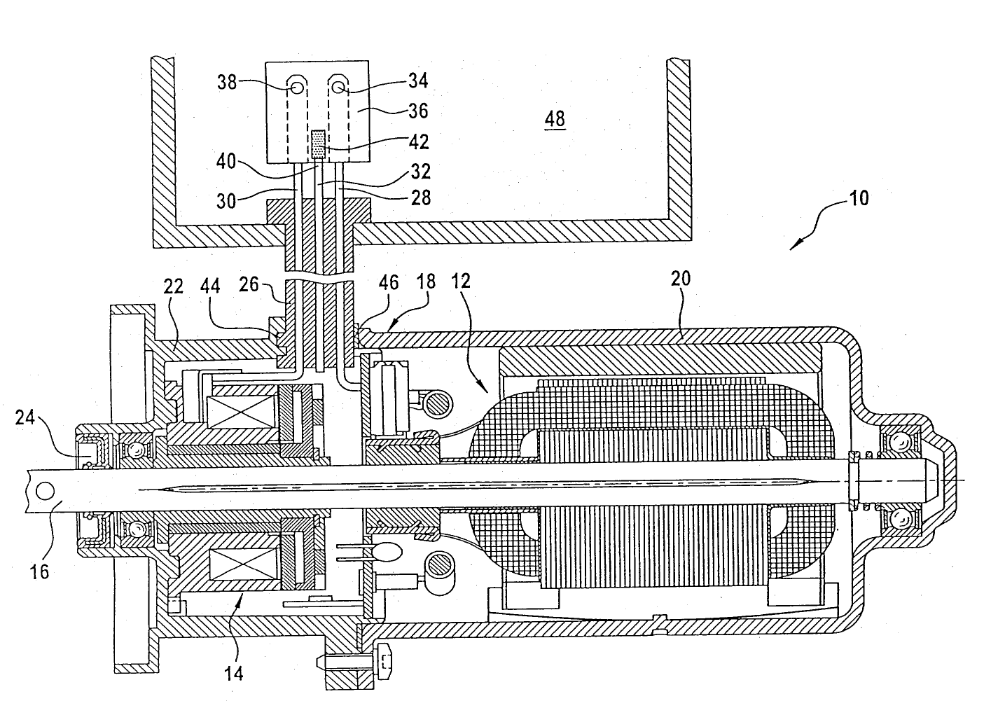

The invention relates to a drive and/or braking device, particularly an actuator unit for a locking differential on a motor vehicle, having an electric drive unit and/or an electromagnetic brake unit, where a shaft can be driven by the drive unit and/or braked by the brake unit, having a closed, specifically water and air-tight housing which holds the drive and/or brake unit, and having a wiring harness to connect the drive and/or brake unit to a source of current.

Such drive and/or braking devices are used particularly in automobile construction to assist the drive and brake systems. They can be used in particular as an actuator to actuate a locking differential of a motor vehicle.

Generic devices have to satisfy extreme requirements. The operating temperature of electromagnetic brakes is in the range of about 200° C. If the device is located in the area of catalytic converters, for example, the operating temperature of the drive device can rise to 200° C. Depending on weather conditions, a sudden, severe cooling of the drive and/or brake device can be the result, for example, when driving through a puddle of water.

The devices must be designed to be air- and water-tight to protect them from environmental influences. With respect to the extreme temperature fluctuations to which the generic devices can be exposed, temperature differences, and therefore pressure differences, occurring inside the device must be taken into consideration.

From the prior art it is known to install labyrinth seals to vent the devices. Such seals, however, are not immersion-proof. It is further known in order to achieve equalization of pressure to install membranes on the device housing. Membranes, however, are not suitable because they are not resistant to jets of steam and/or become non-functional because of contamination.

The purpose of the present invention is to propose a drive and/or brake device which firstly can be configured to be water- and air-tight, and secondly permits pressure equalization because of extreme fluctuations in temperature. At the same time, it should be immersion-proof in particular and resistant to jets of steam.

This purpose is achieved in the case of a drive and/or brake unit of the type described initially under the invention through the wiring harness having at least one hollow lead to vent the interior of the housing.

This has the advantage that pressure can be equalized through the hollow lead without the functional ability of the device being compromised. The hollow lead connects the interior of the housing with ambient and specifically with the vehicle interior. Advantageously no additional components need to be provided, which would involve additional costs to produce and assemble. Instead, existing components, namely an existing wiring harness, are used to attain the stated object. Using the wiring harness, or the hollow lead to be furnished, it is possible for the end of the hollow lead facing away from the device to be located several tens of centimeters up to meters distant from the housing. The end of the hollow lead open to atmosphere can be located at a suitable location so that no undesirable environmental influences, in particular no water, can penetrate into the housing through the hollow lead.

As part of the invention it is conceivable that two or more hollow leads can be furnished inside the wiring harness to improve the venting of the housing interior. Any pressure differences occurring are equalized quickly in this way and without negatively affecting the operation of the device.

In a preferred embodiment of the invention, a connector surrounding the end of the hollow lead is provided at the end of the wiring harness facing away from the drive device. The connector can be used advantageously to connect electrical leads running through the wiring harness. Because the end of the hollow lead facing atmosphere ends in the connector, no additional components surrounding the open end of the wiring harness need to be provided.

As part of the invention it is also conceivable that a filter and/or a valve is located on at least one end of the hollow conduit. This can eliminate the entry of undesirable media, particularly water, through the hollow lead into the gas housing of the device under the invention.

Another embodiment of the invention provides for the wiring harness to be sealed to the housing with a sealing element in the area where it passes through the housing. This sealing element is preferably rubber-like and ensures a water- and air-tight passage for the wiring harness into the interior of the housing.

The hollow lead can preferably end inside the housing immediately after the sealing element.

Under the invention, it is furthermore conceivable that the housing is configured in two sections, where the sealing element is positioned in a recess between the two sections of the housing. One section of the housing is preferably a pot-shaped housing base. The other section of the housing can be a flange-like cover which is bolted to the open side of the housing base. The sealing element sits in the recess between the two sections of the housing, preferably under a specified preload.

Additional advantageous embodiments and details of the invention can be found in the description to follow, in which the invention is explained and described in greater detail using the embodiments shown in the drawing.

A drive and brake device 10 is shown in longitudinal section in the figure. The device 10 is used particularly to active a locking differential for motor vehicles. The device 10 has an electrical drive unit 12 and an electromagnetic brake unit 14. The device 10 has in addition a shaft 16 which can firstly be driven by the drive unit 12 and secondly can be braked by the brake unit 14.

The drive unit 12 and the brake unit 14 are housed in a closed, water- and air-tight housing 18. The housing 18 comprises two housing sections 20 and 22. Housing section 20 has a pot-like configuration and locates the drive unit 12. Housing section 22 can be flanged to housing section 20 and accommodates the brake unit. Shaft 16 extends through housing section 22, where a shaft lip seal 24 is provided between housing section 22 and the shaft 16.

The device 10 also includes a wiring harness 26 to connect to a source of current, which is not shown. The wiring harness 26 shows three leads 28, 30 and 32, by way of example. Lead 28 connects the drive unit 12 to a pin 34 in a connector 36 located at the end of the wiring harness 26 facing away from the housing 18. In the same way, lead 30 connects the electromagnetic brake unit 14 to another pin 38 in the connector 36.

The device 10 also includes a wiring harness 26 to connect to a source of electric current, which is not shown. The wiring harness 26 shows three leads 28, 30 and 32, by way of example. Lead 28 connects the drive unit 12 to a pin 34 in a connector 36 located at the end of the wiring harness 26 facing away from the housing 18. In the same way, lead 30 connects the electromagnetic brake unit 14 to another pin 38 in the connector 36.

Lead 32 is configured as a hollow lead and connects the interior of the housing 18 to atmosphere, or to the vehicle interior, which is indicated by reference numeral 48. The wiring harness 26 in the case of a device 10 under the invention can be from several tens of centimeters to meters in length. Advantageously the wiring harness terminates at a point which is protected from undesirable environmental influences.

The drawing indicates that, at the end 40 of the hollow lead 32 facing away from the housing 18, a filter element 42 is provided which prevents water in particular or undesirable dust particles from entering the hollow lead 32 and thus the housing 18 for the device.

In the area where the wiring harness 26 passes through the housing 18, it is sealed in an air- and water-tight manner to the housing with a rubber-like sealing element 44, which is formed in one piece with the wiring harness. This ensures that undesirable media in the area of the wiring harness 26 cannot penetrate into the housing 18 for the device 10.

The hollow lead 32 terminates inside the housing 18 immediately after it has passed through the sealing element 44.

The sealing element 44 is also positioned in a recess 46 in both housing sections 20 and 22. The sealing element 44 is retained between the two housing sections 20 and 22 under light preload.

The operating temperature of the device 10 is about 180 to 200° C. If a vehicle equipped with a device 10 of this type drives through a puddle of water, the device can be abruptly cooled down.

Because the interior of the device 10 is connected to atmosphere through the hollow lead 32, pressure differences arising inside the device 10 can be equalized immediately and effectively. Formation of critical over pressure or a vacuum inside the device 10 is precluded because of the inventive venting of the device 10.

All the features presented in the description, the claims to follow and the drawing can be fundamental to the invention both individually and in any combination.

What is claimed is:

1. Drive and/or braking device (10), particularly for installation in motor vehicles, having an electric drive unit (12) and/or having an electromagnetic brake unit (14), where a shaft (16) can be driven by the drive unit (12) and/or braked by the brake unit (14), having a closed, specifically water- and air-tight housing (18) accommodating the drive (12) and/or braking unit (14), and having a wiring harness (26) to connect the drive and/or braking device (10) to a source of current, characterized in that the wiring harness (26) has at least one hollow lead (32) to vent the interior of the housing (18).

2. Drive and/or braking device (10) from claim 1, wherein a connector (36) surrounding one end (40) of the hollow lead (32) is furnished at the end (40) of the wiring loom (26) facing away from the driving device (10).

3. Drive and/or braking device (10) from claim 1 or 2, wherein a filter (42) and/or a valve is located on at least one end (40) of the hollow lead (32).

4. Drive and/or braking device (10) from claim 1, 2 or 3, wherein the wiring harness (26) is sealed with a sealing element (44) against the housing (18) in the area where it passes through the housing (18).

5. Drive and/or braking device (10) from claim 4, wherein the sealing element (44) is configured in one piece with the wiring harness (26).

6. Drive and/or braking device (10) from claim 4 or 5, wherein the hollow lead (32) terminates inside the housing (18) immediately after the sealing element (44).

7. Drive and/or braking device (10) from claim 4, 5 or 6, wherein the housing is configured in two parts, where the sealing element (44) is located in a recess (46) between the two sections of the housing (20, 22).
